(19) United States
(12) Patent Application Publication
(10) Pub. No.: US 2007/0000222 A1
(43) Pub. Date: Jan. 4, 2007

(54) ELECTRICAL PEDAL POWER MOWER

(76) Inventor: James W. LAWBAUGH, Williams, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/160,610

(22) Filed: Jun. 30, 2005

(51) Int. Cl. A01D 43/08

(52) U.S. Cl. 56/2

(57) ABSTRACT

A pedal powered mower having a frame with a gear assembly to allow manual operation of the mower. Attached to the frame is a blade assembly that when actuated cuts grass. The gear and blade assembly are operably connected by at least one chain such that when the gear assembly is actuated the blade assembly will cause the blade to rotate. On the frame is a motor that is connected to the gear assembly, blade assembly, or chain to assist in the operation of the bicycle.

### BACKGROUND OF THE INVENTION

This invention is directed toward a grass mowing device and more specifically, a mowing device that utilizes both manual and electric power sources to operate the mower.

Pedal operated lawn mowers are known in the art. Most have a pair of rear wheels with mower cutting blades that extend between the rear wheels. A chain extends between a pedal sprocket and a rear axle sprocket, and pedaling the bicycle results in rotation of the blade as well as the wheels.

While pedal operated lawnmowers eliminate the cost of fuel and pollution associated with engine powered lawnmowers, pedal operated mowers are difficult to operate over rough and inclined terrain or when an operator tires. Pedal operated mowers also take longer to traverse the mowing area and are therefore less efficient. Accordingly, there is a need for a pedal operated mower that addresses the problems in the art.

Therefore, an object of the present invention is to provide a pedal operated mower that is supplemented with electrical power.

A further object of the present invention is to provide a pedal operated mower that better traverses rough and inclined terrain.

These and other objects, features, or advantages will become apparent from the specification and the claims.

### BRIEF SUMMARY OF THE INVENTION

A lawnmower having a frame with a gear assembly that has pedals to allow manual operation of the bicycle lawnmower. Attached to the frame is a blade assembly having a cutting blade that when actuated cuts grass. The gear and blade assembly are operably connected by at least one chain such that when the gear assembly is actuated the blade assembly will cause the blade to rotate. Mounted on the frame is a motor that is connected to the gear assembly, blade assembly, or chain in order to provide extra power to assist in the operation of the bicycle.

### BRIEF DESCRIPTION OF THE DRAWINGS

FIG. 1 is a side view of a pedal lawnmower; and

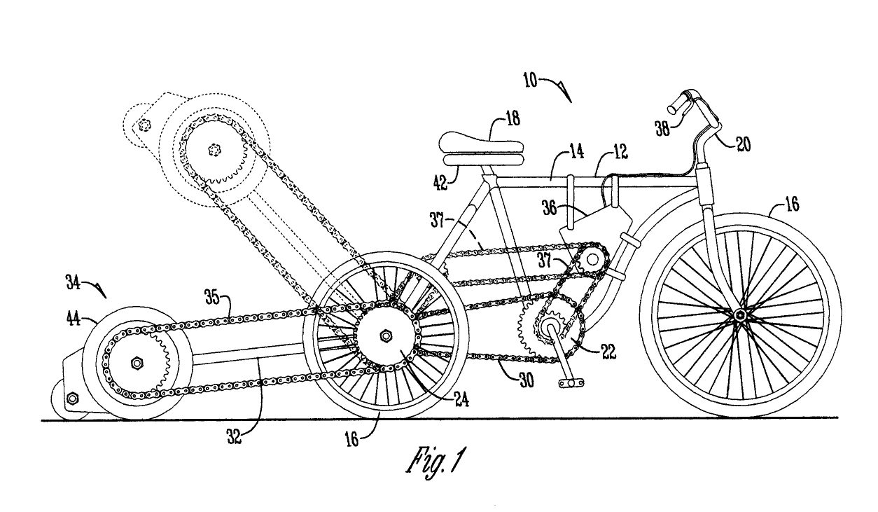

FIG. 2 is a top plan view of a pedal lawnmower.

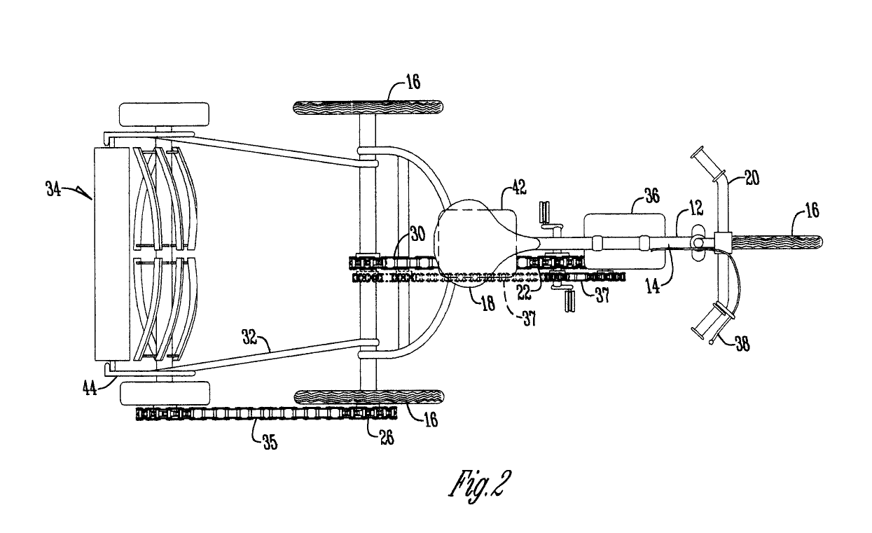

### DETAILED DESCRIPTION OF THE PREFERRED EMBODIMENT

Referring to the Figures, a pedal powered mower 10 has a framework 12 comprised of a plurality of metal tubular members 14 mounted on a plurality of wheels 16. Mounted to the frame 12 is a seat 18 and a steering bar 20. Conventional means of propulsion is provided in the form of a gear assembly having a pedal sprocket 22, rear wheel sprocket 24, and chain 30. Other features, such as brakes, gears, and the like may also be included but for convenience are not described or shown in the present Figures.

Hingedly mounted to the frame 12 by a bracket 32, is a rotary cutting blade assembly 34. The cutting blade assembly 34 is operatively connected to the pedal sprocket 22 by chain 35 such that mechanical energy is transferred to the cutting blade assembly 34 to rotate the blade. The hinged bracket 32 permits the cutting blade assembly 34 to fold back toward the frame 12 during non-use to create a compact unit.

Mounted on the frame 12 is a motor 36. The motor 36 is of any type, but for environmental purposes, preferred is an electrical or battery powered motor. The motor 36 is connected to a sprocket 39 adjacent to the pedal sprocket 22 in any conventional manner such as by chain 37 so that power from the motor 36 is supplied to the pedal sprocket 22 to assist in the rotation of the pedal sprocket. Alternatively, the motor 36 is operatively connected to both the pedal sprocket 22 and the cutting blade assembly 34 via chains. Additionally, and/or alternatively, the motor 36 is connected to the blade assembly 34 only. A lever 38, preferably mounted to the steering bar 20, is connected to the motor 36 via a cable 40 or the like, which allows an operator to selectively activate the motor 36.

Mounted to the seat 18 is a battery 42 which provides power to the motor 36. The battery is connected to the motor 36 by cable 40 and is also connected to an alternator 44 that is preferably mounted to the blade assembly 34. As the blade assembly 34 rotates, energy is transferred by the alternator 44 to the battery 42 for later use.

In operation, an operator rotatably engages the pedal sprocket 22. As the pedal sprocket 22 rotates, rear wheel sprocket 24, and cutting blade assembly likewise rotate via energy transferred from sprocket 22 via chain 30. At any time, such as when rough terrain or an incline is encountered, the operator may activate lever 38 which actuates motor 36. Once actuated, motor 36 supplies additional power to sprocket 22 and/or blade assembly 34.

The use the motor in combination with the pedal sprocket, rear wheel sprocket, and cutting blade assembly assists a rider when mowing the grass. Particularly, the combination allows a rider to more easily traverse difficult terrain, add additional power when the operator fatigues, and creates a more cost efficient pedal powered mower. Thus, at least all the stated objectives have been met.

It will be appreciated by those skilled in the art that other various modifications could be made to the device without departing from the spirit in scope of this invention. All such modifications and changes fall within the scope of the claims and are intended to be covered thereby.

1. A pedal powered mower, comprising:
a frame;
a gear assembly having a pedal sprocket and a rear wheel sprocket connected by a first chain secured to the frame;
a blade assembly operably connected to the rear wheel sprocket by a second chain and secured to the frame; and
a motor attached to the gear assembly.

2. The mower of claim 1 wherein the blade assembly is hingedly mounted to the frame.

3. The mower of claim 1 further comprising a lever operably attached to the motor to selectively activate the motor.

4. The mower of claim 1 wherein the motor is powered by a battery.

5. The mower of claim 4 wherein the battery is charged by rotation of the blade assembly.

6. The pedal power mower of claim 1 further comprising:
a battery attached to the frame and connected to the motor via a cable; and an alternator mounted to the blade assembly and connected to the cable such that when the blade assembly rotates, energy is transferred by the alternator to the battery.

7. A pedal power mower comprises:
a frame;
a gear assembly having a pedal sprocket and a rear wheel sprocket connected by a first chain secured to the frame;
a blade assembly operably connected to the rear wheel sprocket by a second chain and secured to the frame;
a motor connected to a motor sprocket adjacent to and connected to the pedal sprocket by a third chain so that power from the motor is supplied to the pedal sprocket to assist rotation of the pedal sprocket and wherein the motor is connected to the blade assembly via fourth chain.

8. The pedal power mower of claim 7 further comprising a lever mounted to the frame and connected to the motor via the cable that allows an operator to selectively activate the motor.

9. The pedal power mower of claim 8 further comprising: a battery attached to the frame and connected to the motor via the cable; and an alternator mounted to the blade assembly and connected to the cable such that when the blade assembly rotates, energy is transferred by the alternator to the battery.
